(19) United States
(12) Patent Application Publication
(10) Pub. No.: US 2017/0030567 A1
(43) Pub. Date: Feb. 2, 2017

(54) LIQUID-COOL LIGHT EMITTING DIODES LIGHT

(71) Applicant: NATIONAL CENTRAL UNIVERSITY, TAOYUAN COUNTY (TW)

(72) Inventors: CHING-CHERNG SUN, TAOYUAN COUNTY (TW); YU-YU CHANG, KAOHSIUNG CITY (TW); YI-JING CHUNG, KAOHSIUNG CITY (TW)

(21) Appl. No.: 14/809,382

(22) Filed: Jul. 27, 2015

(51) Int. Cl. F21V 29/56; F21K 99/00; F21V 29/503

(52) U.S. Cl. CPC F21V 29/56; F21V 29/503; F21K 9/56; F21Y 2101/02

(57) ABSTRACT

A liquid-cool Light Emitting Diodes light includes a light source having multiple LED units. A cooling unit includes a first cooling member connected to the first face of the light source, and a second cooling member connected to the second face of the light source. A cooling system has a cooling device, a first path and a second path. The first path of the cooling device is connected to two respective first ends of the first and second cooling members. The second path of the cooling device is connected to two respective second ends of the first and second cooling members. The heat generated from the LED units is efficiently removed and with small emitting area.

### BACKGROUND OF THE INVENTION

1. Fields of the Invention

The present invention relates to a Light Emitting Diodes light, and more particularly, to a liquid-cool Light Emitting Diodes light.

2. Descriptions of Related Art

The conventional lighting device generally comprises multiple lights which provide sufficient illumination. However, these lights consume significant electric power and generate heat of high temperature which has to be removed efficiently so as to protect the lights. In other words, multiple heat dissipation devices are required to be cooperated with the multiple lights. The lights together with their bases or casings, and the heat dissipation devices occupy space.

Light Emitting Diodes (LEDs) are developed to improve the shortcomings mentioned above, the LEDs are compact and provide sufficient brightness. Nevertheless, the heat removal of the LEDs is the main concern when using LEDs because usually hundreds LEDs are used. Although the conventional way to remove the heat can be made by using heat dissipation fins, the heat dissipation fins cannot attached to the LEDs when the LEDs are used on a large display screen.

The present invention intends to provide a liquid-cool LEDs light which eliminates the shortcomings mentioned above.

### SUMMARY OF THE INVENTION

The present invention relates to a liquid-cool Light Emitting Diodes light and comprises a light source having multiple Light Emitting Diode units (LED units). The light source has a first face and a second face. A cooling unit has a first cooling member which is connected to the first face, and a second cooling member which is connected to the second face. A cooling system has a cooling device, a first path and a second path. The first path of the cooling device is connected to two respective first ends of the first and second cooling members, and the second path of the cooling device is connected to two respective second ends of the first and second cooling members.

Preferably, the first cooling member is a transparent member.

Preferably, a fluorescent layer is located between the LED units and the first face.

Preferably, the first cooling member has fluorescent powder received therein. A filter is connected between the first cooling member and the first path, and another is connected between the second cooling member and the second path.

Preferably, the cooling system is a water-cooling system. The cooling device has a heat dissipation unit, a storage unit and a pump unit. The heat dissipation unit has a heat dissipation member and a fan. The storage unit is connected between the heat dissipation unit and the pump unit. The heat dissipation unit is connected with the second path. The heat dissipation unit is located between the storage unit and the second path. The pump unit is connected between the storage unit and the first path.

Preferably, the first cooling member is connected to a light softening device which is located opposite to the LED units.

Preferably, the light softening device is connected with a second optic units (including lens and reflector) which is located opposite to the first cooling member.

Alternatively, the present invention provides another liquid-cool Light Emitting Diodes light which comprises a light source having multiple LED units. A cooling unit has a room in which the light source is received. A cooling system has a cooling device, a first path and a second path. The first path of the cooling device is connected to a first end of the cooling unit, and the second path of the cooling device is connected to a second end of the cooling unit.

Preferably, the cooling system is a water-cooling system. The first cooling member is a transparent member. A fluorescent layer is connected to the cooling unit and located opposite to the light source.

Preferably, the cooling device receives non-conductive cooling liquid therein. A transparent single-crystal alumina layer is located between the fluorescent layer and the cooling unit.

The primary object of the present invention is to provide a liquid-cool Light Emitting Diodes light with high efficiency for removal of heat generated from the Light Emitting Diodes, while the liquid-cool Light Emitting Diodes light occupies less space and small emitting area.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the first embodiment of the liquid-cool Light Emitting Diodes light of the present invention;

FIG. 2 is an enlarged view to show a portion of the first embodiment of the liquid-cool Light Emitting Diodes light of the present invention;

FIG. 3 shows the second embodiment of the liquid-cool Light Emitting Diodes light of the present invention, and

FIG. 4 shows the third embodiment of the liquid-cool Light Emitting Diodes light of the present invention.

### DETAILED DESCRIPTION OF THE PREFERRED EMBODIMENT

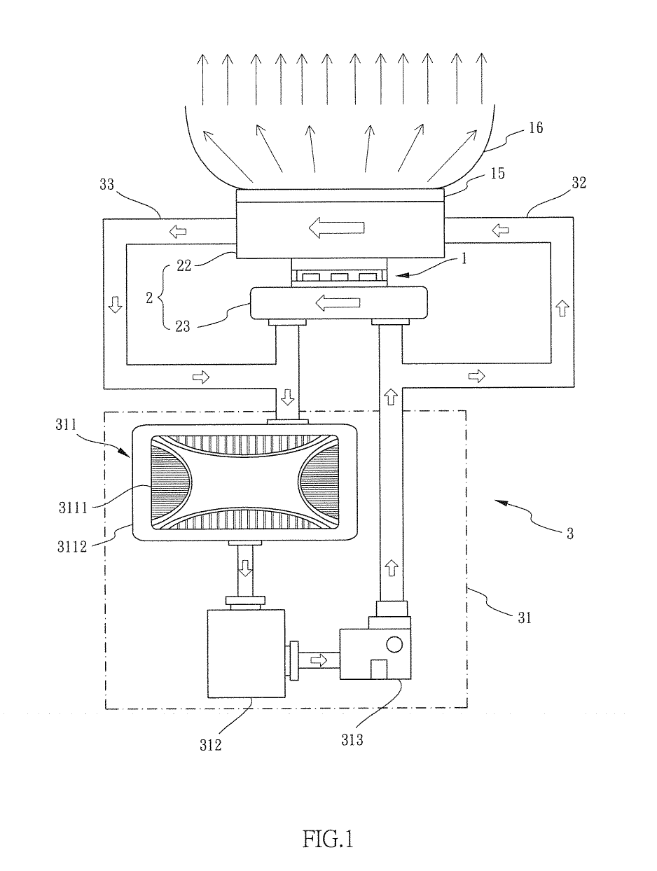

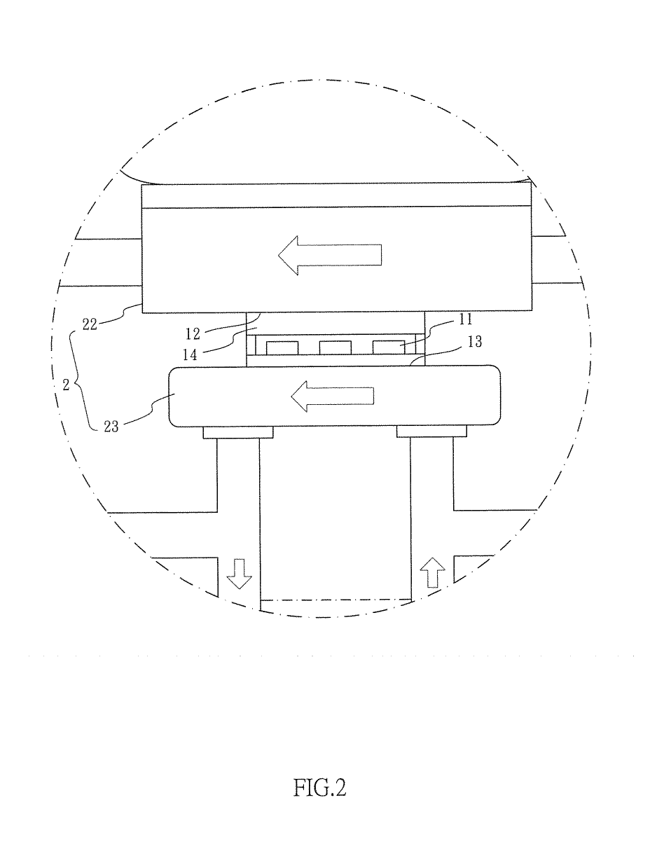

Referring to FIGS. 1 to 2, the liquid-cool Light Emitting Diodes light of the present invention comprises a light source 1 having multiple Light Emitting Diode units 11 (LED units). The light source 1 has a first face 12 and a second face 13. A cooling unit 2 has a first cooling member 22 and a second cooling member 23, wherein the first cooling member 22 is connected to the first face 12, and the second cooling member 23 is connected to the second face 13. A cooling system 3 has a cooling device 31, a first path 32 and a second path 33. The first path 32 of the cooling device 31 is connected to the two respective first ends of the first and second cooling members 22, 23, and the second path 33 of the cooling device 31 connected to the two respective second ends of the first and second cooling members 22, 23.

Heat generated from the LED units 11 is transferred to the cooling device 2 by cooling liquid circulates in the cooling system 3 and the cooling device 2. The heat is then removed from the cooling device 2 to the cooling system 3, and released to the outside air. Specifically, the heat generated from the LED units 11 is transferred to the first and second cooling members 22, 23 via the first and second faces 12, 13, and the cooling liquid absorbs the heat from the first and second cooling members 22, 23 to the cooling system 3 which releases the heat to the outside air.

The first face 12 is a light emitting face and the first cooling member 22 is a transparent member, such as glass so that the light generated from the LED units 11 passes through the first cooling member 22.

A fluorescent layer 14 is located between the LED units 11 and the first face 12 so as to increase the illumination feature of the light from the LED units 11. For example, when using yellow fluorescent layer 14, the light becomes while light when mixed with the light from the blue LED units 11.

The cooling system 3 is a water-cooling system. The cooling device 31 has a heat dissipation unit 311, a storage unit 312 and a pump unit 313. The heat dissipation unit 311 has a heat dissipation member 3111 and a fan 3112. The storage unit 312 is connected between the heat dissipation unit 311 and the pump unit 313. The heat dissipation unit 311 is connected with the second path 33. The heat dissipation unit 311 is located between the storage unit 312 and the second path 33. The pump unit 313 is connected between the storage unit 312 and the first path 32. The cooling system 3 uses the storage unit 312 to store the cooling liquid. When the cooling system is in action, the pump unit 313 pumps the cooling liquid in the storage unit 312 to circulate between the cooling system 3 and the cooling device 2. Specifically, the cooling liquid passes through the first path 32 and enters into the first and second cooling members 22, 23 to absorb the heat from the first and second cooling members 22, 23. The cooling liquid then flows through the second path 33, the heat dissipation unit 311, the heat is then transferred to the heat dissipation member 3111 and released to the outside air.

The first cooling member 22 is connected to a light softening device 15 which is located opposite to the LED units 11. The light softening device 15 eliminates the wrinkles generated by water. The light softening device 15 is connected with a second optic units (including lens and reflector) 16 which is located opposite to the first cooling member 22 so as to send the light to a farer distance.

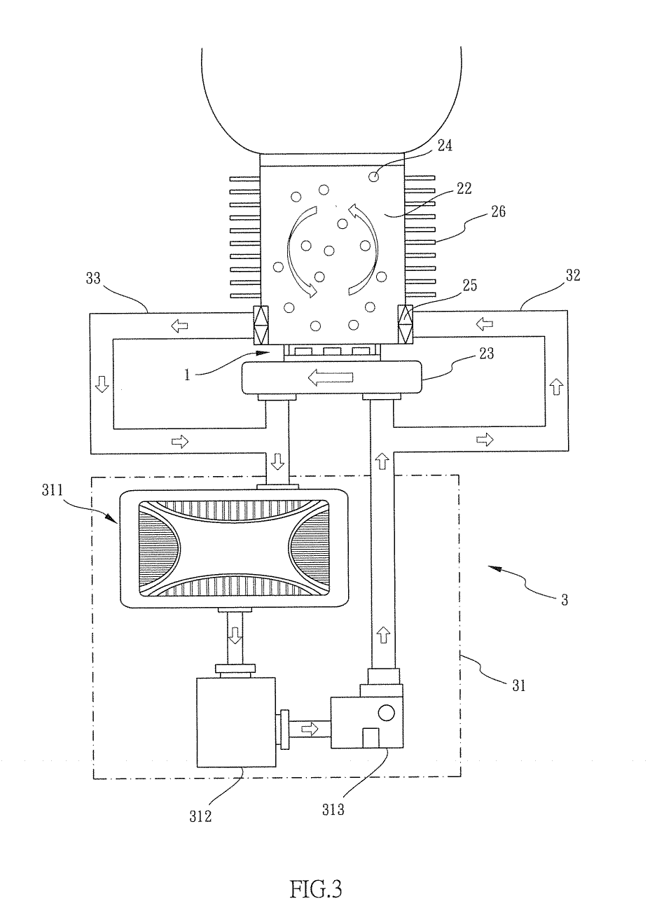

As shown in FIG. 3, the second embodiment of the present invention is provided, wherein the differences from the first embodiment are that the first cooling member 22 has fluorescent powder 24 received therein. A filter 25 is connected between the first cooling member 22 and the first path 32, and another 25 is connected between the second cooling member 23 and the second path 33. These filters 25 ensures that a proper amount of the fluorescent powder 24 is received in the first cooling member 22, and the fluorescent powder 24 is not flushed away by the cooling liquid. In this embodiment, when the first cooling member 22 is filled with the cooling liquid, the fluorescent powder 24 is evenly spread in the first cooling member 22 by the movement of the cooling liquid. Because the first cooling member 22 is a transparent member so that the light from the LED units 11 passing through the first cooling member 22 changes its color because of the fluorescent powder 24. Besides, the fluorescent powder 24 can be a mixture of different colors of the fluorescent powder 24 to generate a desired color. Besides, the fluorescent powder 24 is spread in the cooling liquid and flows with the cooling liquid, the heat energy to the fluorescent powder 24 can be brought to the cooling system 3 to increase the efficiency of heat dissipation. The first cooling member 22 may be cooperated with fins 26 connected to outside thereof.

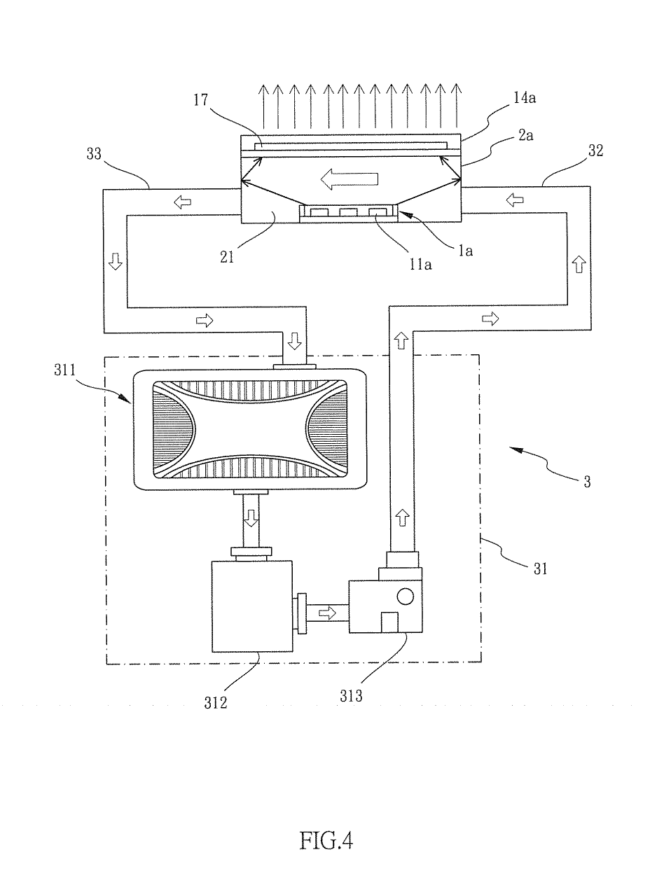

FIG. 4 shows the third embodiment of the present invention, the liquid-cool Light Emitting Diodes light comprises a light source 1a having multiple Light Emitting Diode units 11a (LED units). A cooling unit 2a has a room 21 in which the light source 1a is received. A cooling system 3 has a cooling device 31, a first path 32 and a second path 33. The first path 32 of the cooling device 31 is connected to a first end of the cooling unit 2a, and the second path 33 of the cooling device 31 is connected to a second end of the cooling unit 2a.

In this embodiment, the cooling system 3 is a water-cooling system, and the first cooling member 22 is a transparent member. A fluorescent layer 14a is connected to the cooling unit 2a and located opposite to the light source 1a. The cooling device 31 receives non-conductive cooling liquid therein. A transparent single-crystal alumina layer 17 is located between the fluorescent layer 14a and the cooling unit 2a. When the light source 1a is activated, the light passes through the cooling liquid and the cooling unit 2a, and the transparent single-crystal alumina layer 17 softens the light which changes its color by the fluorescent layer 14a. The light source 1a is received in the room 21 of the cooling unit 2a and soaked in the cooling liquid when the cooling system 2 is in operation. The cooling liquid is non-conductive cooling liquid so as to avoid from circuit short and the light source 1a operates normally. The heat from the light source 1a is effectively removed.

While we have shown and described the embodiment in accordance with the present invention, it should be clear to those skilled in the art that further embodiments may be made without departing from the scope of the present invention. cm What is claimed is:

1. A liquid-cool Light Emitting Diodes light, comprising:
a light source having multiple Light Emitting Diode units (LED units), the light source having a first face and a second face;
a cooling unit having a first cooling member and a second cooling member, the first cooling member connected to the first face, the second cooling member connected to the second face, and
a cooling system having a cooling device, a first path and a second path, the first path of the cooling device connected to two respective first ends of the first and second cooling members, the second path of the cooling device connected to two respective second ends of the first and second cooling members.

2. The liquid-cool Light Emitting Diodes light as claimed in claim 1, wherein the first cooling member is a transparent member.

3. The liquid-cool Light Emitting Diodes light as claimed in claim 2, wherein a fluorescent layer is located between the LED units and the first face.

4. The liquid-cool Light Emitting Diodes light as claimed in claim 2, wherein the first cooling member has fluorescent powder received therein, a filter is connected between the first cooling member and the first path, another is connected between the second cooling member and the second path.

5. The liquid-cool Light Emitting Diodes light as claimed in claim 1, wherein the cooling system is a water-cooling system, the cooling device has a heat dissipation unit, a storage unit and a pump unit, the heat dissipation unit has a heat dissipation member and a fan, the storage unit is connected between the heat dissipation unit and the pump unit, the heat dissipation unit is connected with the second path, the heat dissipation unit is located between the storage unit and the second path, the pump unit is connected between the storage unit and the first path.

6. The liquid-cool Light Emitting Diodes light as claimed in claim 5, wherein the first cooling member is connected to a light softening device which is located opposite to the LED units.

7. The liquid-cool Light Emitting Diodes light as claimed in claim 6, wherein the light softening device is connected with a reflection unit which is located opposite to the first cooling member.

8. A liquid-cool Light Emitting Diodes light, comprising:
a light source having multiple Light Emitting Diode units (LED units);
a cooling unit having a room in which the light source is received, and
a cooling system having a cooling device, a first path and a second path, the first path of the cooling device connected to a first end of the cooling unit, the second path of the cooling device connected to a second end of the cooling unit.

9. The liquid-cool Light Emitting Diodes light as claimed in claim 8, wherein the cooling system is a water-cooling system, the first cooling member is a transparent member, a fluorescent layer is connected to the cooling unit and located opposite to the light source.

10. The liquid-cool Light Emitting Diodes light as claimed in claim 9, wherein the cooling device receives non-conductive cooling liquid therein, a transparent single-crystal alumina layer is located between the fluorescent layer and the cooling unit.
